(19) United States
(12) Patent Application Publication
(10) Pub. No.: US 2020/0285289 A1
(43) Pub. Date: Sep. 10, 2020

(54) Apparatus for Powering a Laptop Computer Without an Extension Cord Using Rechargeable Batteries Compatible with Conventional Power Outlets

(71) Applicant: Isaac Aaron Buckley, Oregon City, OR (US)

(72) Inventor: Isaac Aaron Buckley, Oregon City, OR (US)

(21) Appl. No.: 15/929,875

(22) Filed: May 27, 2020

(51) Int. Cl. G06F 1/26; H02J 7/02; H01R 13/44; G06F 1/16

(52) U.S. Cl. CPC G06F 1/263; H02J 7/02; H01R 13/04; G06F 1/1635; G06F 1/1679; H01R 13/44

(57) ABSTRACT

An apparatus for powering a laptop computer without using a power cord. The laptop is sold with two interchangeable batteries, which can charge by being plugged directly into a wall outlet, along with an internal battery to power the laptop during battery changes.

### CROSS-REFERENCE TO RELATED APPLICATIONS

Not applicable.

### FIELD

This invention relates in general to the powering of electronic devices, and more particularly to methods for powering laptop computers without requiring an extension cord.

### BACKGROUND

The ubiquity of electronic devices has brought about both novel opportunities and conveniences to our everyday lives, while also introducing new challenges. Every one of our devices require some means of obtaining energy in order to function, the methods currently most common of which utilize an extension cord (such as a computer's power cord, a Universal Serial Bus, etc.) at some point in the process in order to provide charge to the device.

Various problems, from simple inconveniences to more serious hazards, have been introduced due to the widespread use of extension cords. In particular, power cords can be difficult to pack and transport, are often tripping (and sometimes, especially for small children and animals, strangulation) hazards, and can become damaged and short out; in addition, a compromised cord, particularly in cases in which its wire has been exposed due to its insulation being crushed, melted as the result of overheating, or abraded over time, often introduces risks such as electrocution and fire. Furthermore, power cords that become either too damaged to safely use, or otherwise nonfunctioning, result in the common need to buy replacements; consequently leading to additional costs to consumers, increased production by manufacturers, deleterious environmental effects, and further depletion of valuable resources. Due to a current lack of easily-available alternatives to powering electronic devices, solving issues such as these requires some innovation; the invention here described was conceived as a means of ameliorating such difficulties, by providing a new option for powering laptop computers without requiring an extension cord at any point in the process.

### SUMMARY

The invention is an apparatus for powering laptop computers, and consists primarily of rechargeable, interchangeable batteries, which are charged via a wall outlet using unfolding blades and an internal power adapter; each laptop includes two such batteries, so that one may be used to power the computer while the other is charging. The laptop contains a locking mechanism, whereby an interchangeable battery is kept in place while in use; as well as a smaller, auxiliary battery, allowing the computer to still run during battery changes. This system improves upon existing technology in that it provides a new way for powering laptop computers without the use of a power cord, thus eliminating several inconveniences and hazards for consumers, and utilizes easily portable components compatible with conventional home electrical outlets.

This Summary presents only a small selection of the various concepts described in further detail by the Detailed Description and associated drawings, and is not intended to be used to limit the scope of the claimed subject matter.

### BRIEF DESCRIPTION OF THE ACCOMPANYING DRAWINGS

FIG. 1 is a perspective view showing the front of an interchangeable battery, with the non-polarized blades folded into place.

FIG. 2 is a perspective view showing the front of an interchangeable battery, with the non-polarized blades extended.

FIG. 3 is a perspective view of the back of a laptop with an interchangeable battery, showing how the battery slides in and out of its receptacle at the base of the laptop.

FIG. 4 is a perspective view of the back of a laptop with an interchangeable battery, showing how the battery is locked into place via the sliding switch.

FIG. 5 is a perspective view of the front of a laptop with an interchangeable battery, with the battery inserted into the battery receptacle.

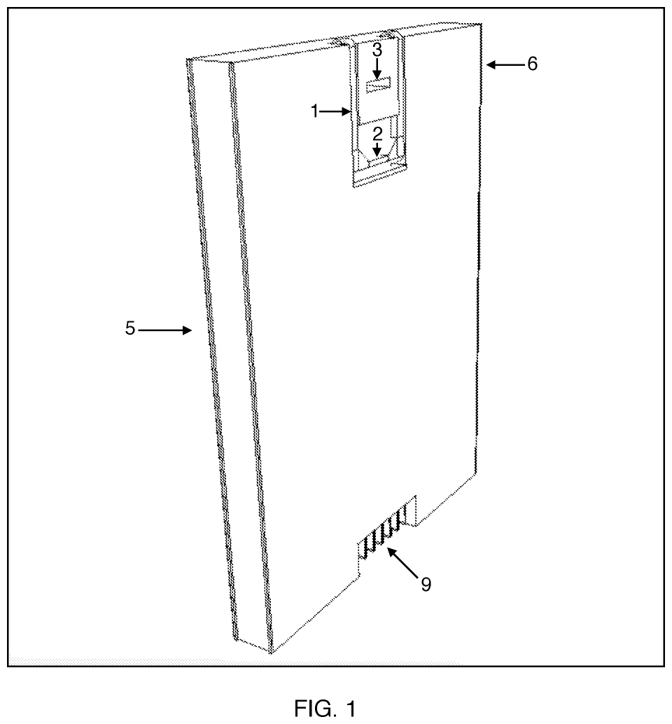

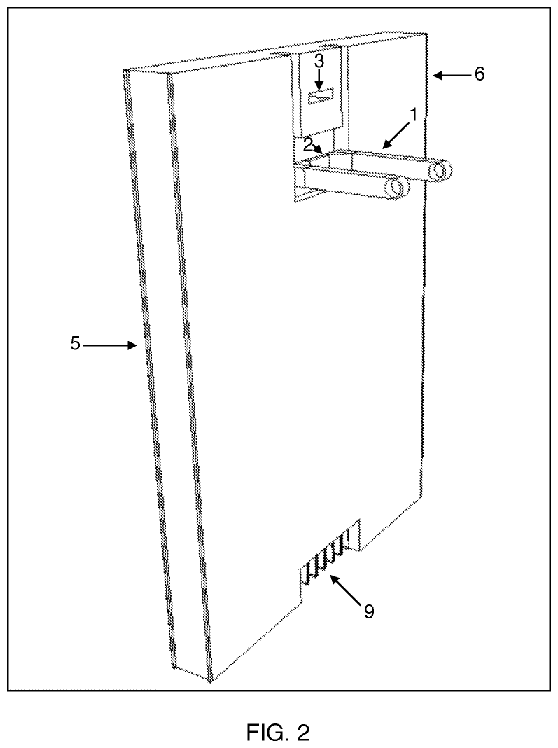

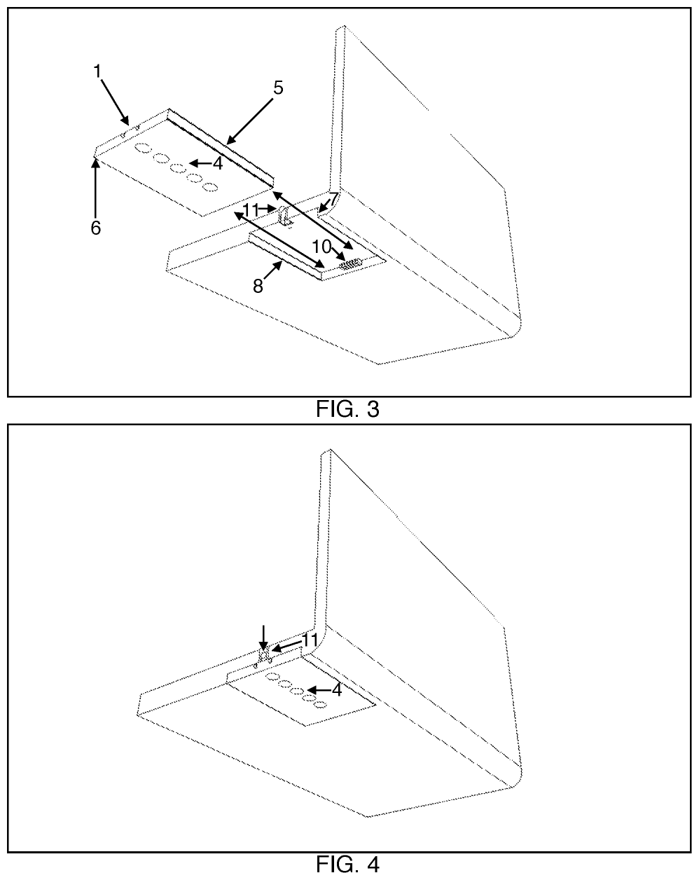

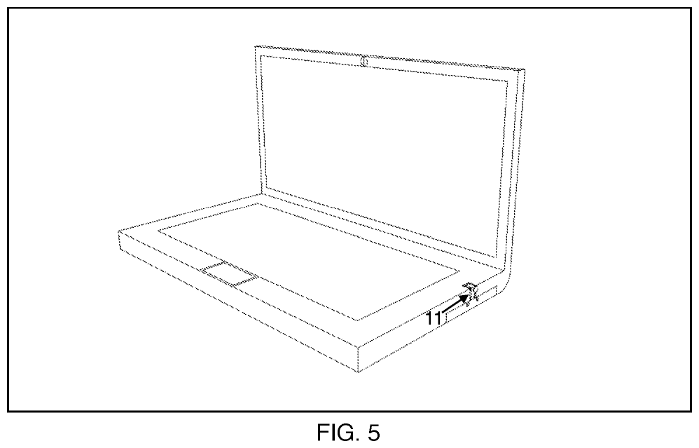

### DETAILED DESCRIPTION

The primary components of the invention are modified conventional rechargeable laptop computer batteries, consisting of a collection of cells (such as lithium ion) within a rectangular, plastic housing; they each include two non-polarized blades equivalent to a NEMA 1-15P plug (1), which unfold via an axle (2) attached to their bases from receptacles built into the top edge of an AD/DC power adapter at the front of the housing, which allow the battery to charge directly from NEMA 1-15R and NEMA 5-15R receptacles. The axle is made with a small indentation in its center, to help users to unfold the blades with greater ease; above which is a receptacle (3) for the sliding lock's latch (see below), to hold the battery in place while in use. A series of light emitting diodes (4) are installed on the rear side of the housing, and are activated based on the level of charge held in the battery, to indicate its power level. In addition, two sets of parallel bars (5, 6) are built onto opposite sides of the housing, which match corresponding grooves (7, 8) inside the battery receptacle at the base of the laptop (see below), allowing the battery to slide in and out of the computer. The power terminal (9) is located at the base of the battery, which connects to a seven-pin male socket (10) built into the laptop's battery receptacle (sea below) while in use. At least two such batteries are included with each laptop, so that one may power the computer while the other is charging.

Another component of the invention concerns the locking mechanism built into the right side of the base of the laptop, which consists of a receptacle for the battery with two sets of parallel grooves that correspond to the bars on the housings of the interchangeable batteries (see above), allowing the battery to easily slide in and out during battery changes; and a sliding lock, which consists of a metal latch operated by a sliding switch (11), which holds the detachable battery in place while in use, and by which a user may detach the battery during battery changes.

A seven-pin male battery connector socket (10) is installed at the far end of the rails of the battery receptacle, allowing charge to flow to the computer from the battery once it has been slid into place.

While in use, the detachable battery charges an internal, auxiliary battery within the laptop, which powers the computer during battery changes.

The invention claimed is:

1. An apparatus for powering a laptop computer without a power cord, comprising:
(1) Interchangeable, rechargeable batteries, each including an internal AD/DC adapter and two unfolding blades equivalent to a NEMA 1-15P plug, whereby the battery may charge directly from a wall outlet.
(2) A locking mechanism within the laptop to keep an interchangeable battery in place while in use.
(3) An internal, auxiliary battery within the laptop to power the computer during battery changes.
